(19) United States
(12) Patent Application Publication
(10) Pub. No.: US 2006/0130093 A1
(43) Pub. Date: Jun. 15, 2006

(54) Electronic program guide display and cursor control

(76) Inventors: Liangkui Feng, San Ramon, CA (US); Qinggen Chen, Fremont, CA (US)

Correspondence Address: PATENT LAW GROUP LLP, 2635 NORTH FIRST STREET, SUITE 223, SAN JOSE, CA, 95134, US

(21) Appl. No.: 11/014,441

(22) Filed: Dec. 15, 2004

(51) Int. Cl. H04N 5/445; G06F 3/00; G06F 13/00

(52) U.S. Cl. 725/39; 725/37; 725/40; 725/44

(57) ABSTRACT

An electronic program guide includes a first program listing for a single start time and a second program listing for a television station identified in the first program listing. The first program listing displays a time of the start time, a first list of television stations and titles of television programs corresponding to the television stations, and a cursor visually identifying one of the television stations and one of the television programs in the first list. The second program listing displays the identified television station and a second list of start times and titles of television programs corresponding to the start times.

### FIELD OF INVENTION

This invention relates to electronic program guides (EPGs) and interactive program guides (IPGs).

### DESCRIPTION OF RELATED ART

U.S. Pat. Nos. 5,479,268 and 5,809,204 describe a user interface for displaying grid-format television schedule listings, such as those found in newspapers. Program listings are placed in a two-dimensional grid with time arranged in one dimension and channel in the other. Each grid cell contains a program title and has an irregular length corresponding to program duration. Using a remote control, a view can highlight a program on the grid and push a button to watch, record, or obtain supplemental information about a program.

### BRIEF DESCRIPTION OF THE DRAWINGS

FIGS. 1, 2, 3, and 4 illustrate an electronic program guide in one embodiment of the invention.

FIGS. 5 and 6 illustrate changes to the electronic program guide in response to cursor input from a user in one embodiment of the invention.

Use of the same reference numbers in different figures indicates similar or identical elements.

### SUMMARY

In one embodiment of the invention, an electronic program guide includes a first program listing for a single start time and a second program listing for a television station identified in the first program listing. The first program listing displays a time of the start time, a first list of television stations and titles of television programs corresponding to the television stations, and a cursor visually identifying one of the television stations and one of the television programs in the first list. The second program listing displays the identified television station and a second list of start times and titles of television programs corresponding to the start times.

### DETAILED DESCRIPTION

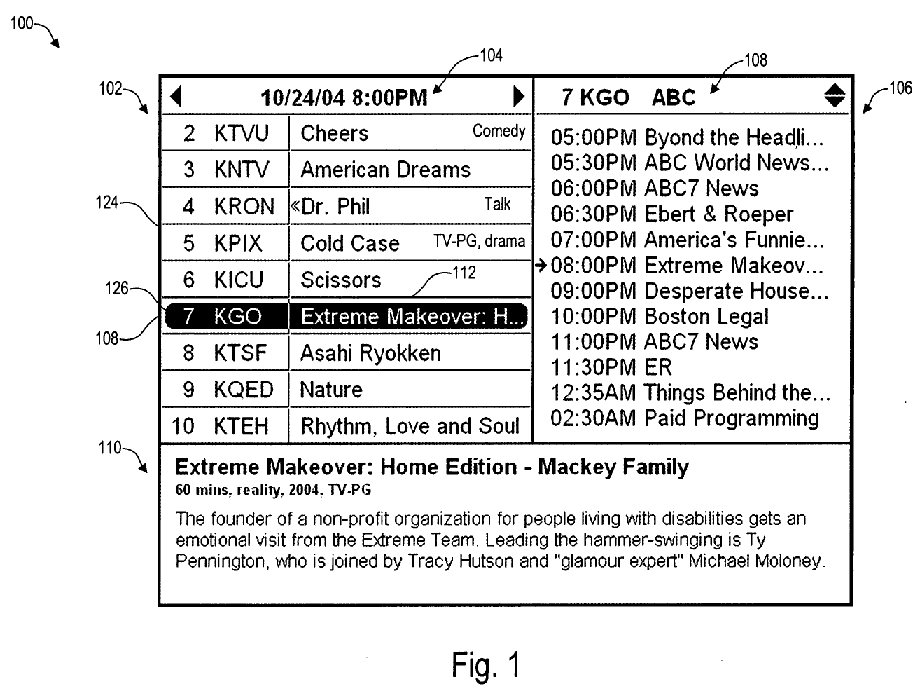

FIG. 1 illustrates an electronic program guide (EPG) 100 in one embodiment of the invention. EPG 100 may be implemented in software, hardware, or a combination therefore in a device such as a personal computer, a digital video recorder (DVR), a video cassette recorder (VCR), a cable television set-top box, or a satellite television set-top box. EPG 100 includes a program listing 102 for a single start time (hereafter “active start time”), a program listing 106 for a television (TV) station visually identified by a cursor 126 (hereafter “active TV station”) in program listing 102, and a program note 110 for a TV program visually identified by cursor 126 (hereafter “active TV program”) in program listing 102.

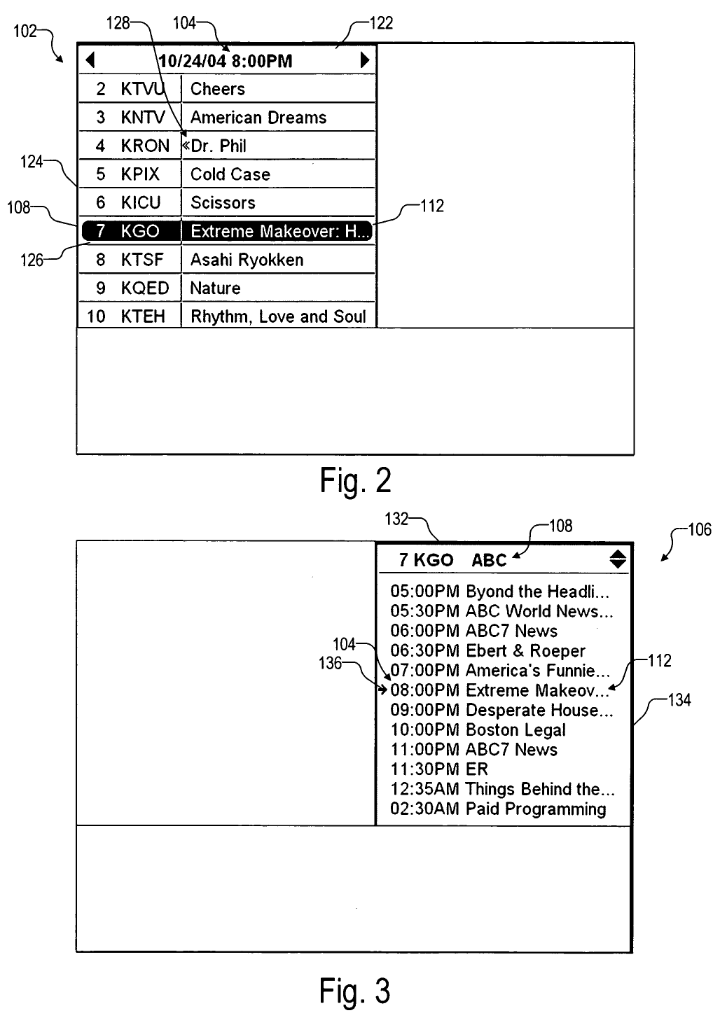

Referring to FIG. 2, program listing 102 includes a pane 122 for displaying the date and an active start time 104, and a pane 124 for displaying a list of TV stations and titles of TV programs scheduled to be broadcasted by the corresponding TV stations at active start time 104. In pane 124, the TV stations are identified by their TV channel numbers and call letters, and the titles of the TV programs may be shortened to fit within the space provided. A user scrolls cursor 126 through pane 124 to view the TV schedule and to visually identify an active TV station 108 and an active TV program 112 for further actions. Cursor 126 visually identifies the active TV station and the active TV program by highlighting one of the TV stations and one of the titles of the TV programs. An arrow 128 placed before the title of a TV program is used to identify a TV program that is scheduled to start prior to active start time 104. Optionally, as shown in FIG. 1, additional information such as ratings and program categories could be provided along with the title of the TV programs.

Referring to FIG. 3, program listing 106 includes a pane 132 for displaying active TV station 108, and a pane 134 for displaying a list of start times and titles of TV programs scheduled to be broadcasted by active TV station 108 at the corresponding start times. In pane 132, TV station 108 is identified by its TV channel number, call letters, and a national network affiliation if any. In pane 134, the titles of the TV programs may be shortened to fit within the space provided. Active start time 104 and active TV program 112 are visually identified by an arrow 136 placed to the left of active start time 104. Preceding start times and TV programs are displayed above active start time 104 and active TV program 112, and subsequent start times and TV programs are displayed below active start time 104 and active TV program 112.

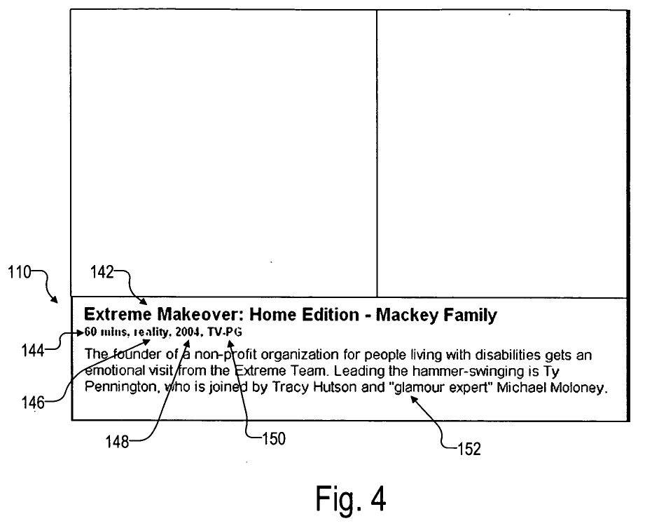

Referring to FIG. 4, program note 110 for active TV program 112 includes a program title 142, a program duration 144, a program category 146, a release year 148, a program rating 150, and a program description 152. Title 142 may be a longer title for active TV program 112. Program note 110 for active TV program 112 is continuously displayed once EPG 100 is activated by the user.

Referring back to FIG. 1, a user can activate EPG 100 by using an input device such as a remote, a keyboard, or a mouse. Once activated, the information initially presented by EPG 100 is based on the current television station that the user is viewing. For example, if the user is currently viewing television station “7 KGO,” then the initial active TV station 108 will be “7 KGO,” the initial active TV program 112 will be the program currently being broadcasted by active TV station 108 (e.g., “Extreme Makeover”), and the initial active start time 104 will be the start time of the initial active TV program 112 (e.g., “8:00 PM”).

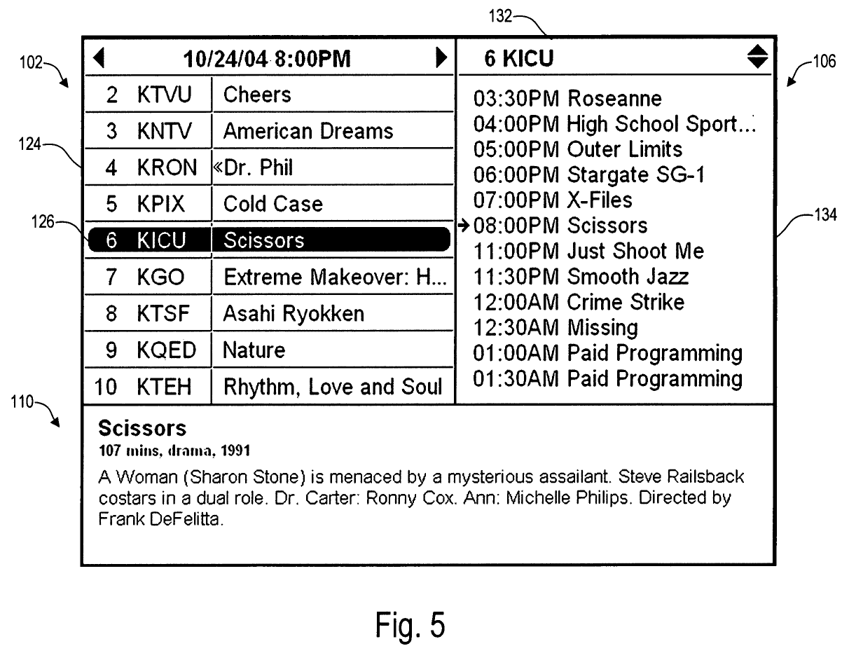

The user can use the input device to move cursor 126 in pane 124. By scrolling up or down, the user can place cursor 126 over a new TV station and a new TV program during active start time 104. For example, the user can scroll up in pane 124 to switch from a currently active TV station “7 KGO” and a currently active TV program “Extreme Makeover” to a newly active TV station “6 KICU” and a newly active TV program “Scissors” that is scheduled to be broadcasted by the newly active TV station “6 KICU” at active start time “8:00 PM.” Referring to FIG. 5, cursor 126 is now placed over the newly active TV station “6 KICU” and the newly active TV program “Scissors.” Program listing 106 and program note 110 are updated in response to the placement of cursor 126 over a new TV station and a new TV program. Pane 132 now displays the newly active TV station “6 KICU” and pane 134 now displays the start times and titles of TV programs for the newly active TV station “6 KICU.” Program note 110 now displays information for the newly active TV program “Scissors.”

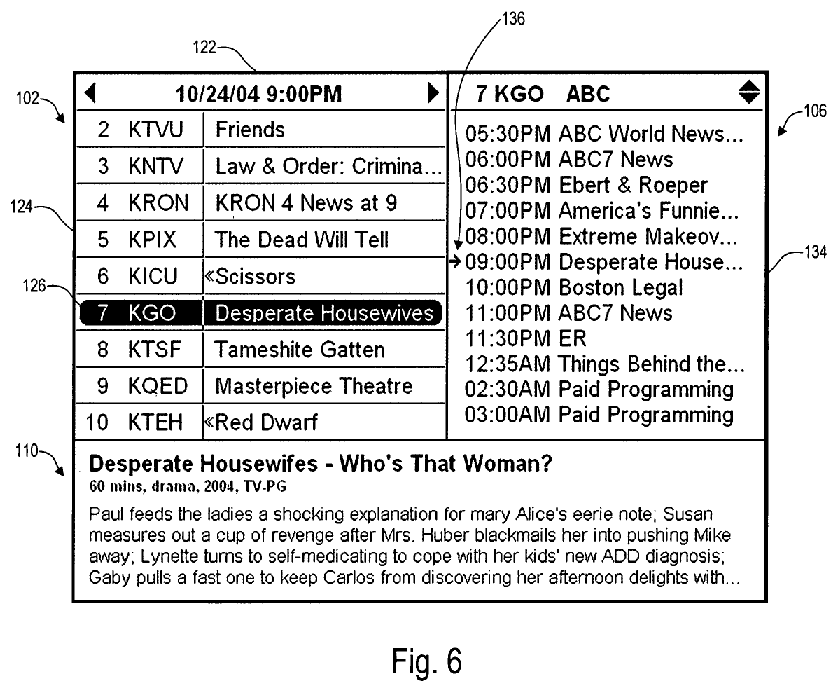

By scrolling left or right, the user can place cursor 126 over the previous or the next TV program scheduled to be broadcasted by active TV station 112. Referring back to FIG. 1 in one example, the user can scroll right to switch from the currently active TV program “Extreme Makeover” to the next TV program “Desperate Housewives.” Referring to FIG. 6, program listing 102, program listing 106, and program note 110 are updated in response to the selection of the newly active TV program. Specifically, program listing 106 now displays the new active start time “9:00 PM” for the new active TV program “Desperate Housewives” in pane 122, and cursor 126 is now placed over the newly active TV program “Desperate Housewives” along with active TV station “7 KGO” in pane 124. Program listing 106 now places arrow 136 next to the start time and title of the newly active TV program “Desperate Housewives” in pane 134. The list of start times and titles may be updated to include additional start times and titles depending if the active start time shifts the list up or down. Program note 110 now displays various information for the newly active TV program “Desperate Housewives.”

After the user places cursor 126 over a desired TV station and TV program, the user can use the input device to select the active TV station and the active TV program for further actions. These actions include the viewing the active TV program, recording of the active TV program, and generating a reminder for the viewing of the active TV program.

Various other adaptations and combinations of features of the embodiments disclosed are within the scope of the invention. Numerous embodiments are encompassed by the following claims.

What is claimed is:

1. An electronic program guide, comprising:
a first program listing for a single start time (“the active start time”), comprising:
time of the active start time;
first list of television stations and titles of television programs corresponding to the television stations;
a cursor visually identifying one of the television stations and one of the titles in the first list (“the active television station” and “the active television program”);
wherein the television programs in the first list are scheduled to be broadcasted by the corresponding television stations at the active start time;
a second program listing for the active television station, comprising:
the active television station;
a second list of start times and titles of television programs corresponding to the start times;
wherein (1) the television programs in the second list are scheduled to be broadcasted by the active television station at the corresponding start times, and (2) the second list includes the active start time and the active television program.

2. The guide of claim 1, wherein the cursor visually identifies the active television station and the active television program by highlighting the active television station and the active television program.

3. The guide of claim 1, wherein the television stations in the first list are identified with at least one of (1) television station channel numbers and (2) television station call letters.

4. The guide of claim 1, wherein the second program listing further includes a visual indicator that identifies the active start time and the active television program in the second list.

5. The guide of claim 4, wherein the visual indicator is an arrow placed next to the active start time in the second list.

6. The guide of claim 1, further comprising:
a program note for the active television program, the program note comprising at least one of (1) a description, (2) a long title, (3) a duration, (4) a category, (5) a release year, and (5) a rating.

7. The guide of claim 1, wherein the first program listing further includes additional information for at least one of the television programs adjacent to its title.

8. The guide of claim 1, wherein the first program listing further includes a visual indicator that identifies a television program that is scheduled to start prior to the active start time.

9. A method for displaying an electronic program guide, comprising:
receiving a request from a user for the electronic program guide;
in response to the request, displaying:
a first program listing for a single start time (“the active start time”), comprising:
a time of the active start time;
a first list of television stations and titles of television programs corresponding to the television stations;
a cursor visually identifying one of the television stations and one of the titles in the first list (“the active television station” and “the active television program”);
wherein the television programs in the first list are scheduled to be broadcasted by the corresponding television stations at the active start time;
a second program listing for the active television station, comprising:
the active television station;
a second list of time slots and titles of television programs corresponding to the time slots;
wherein (1) the television programs in the second list are scheduled to be broadcasted by the active television station at the corresponding start times, and (2) the second list includes the active start time and the active television program.

10. The method of claim 9, wherein the cursor visually identifies the active television station and the active television program by highlighting the active television station and the active television program.

11. The method of claim 9, wherein the television stations in the first list are identified by at least one of (1) television station channel numbers and (2) television station call letters.

12. The method of claim 9, wherein the second program listing further comprises a visual indicator that identifies the active start time and the active television program in the second list.

13. The method of claim 12, wherein the visual indicator is an arrow placed next to the active time slot in the second list.

14. The method of claim 9, further comprising, in response to the request:
displaying a program note for the active television program, the program note comprising at least one of (1) a description, (2) a long title, (3) a duration, (4) a category, (5) a release year, and (5) a rating.

15. The method of claim 9, further comprising:
receiving a first cursor input from the user to scroll in a first direction through the first list;
in response to the first cursor input:
updating the cursor in the first program listing to indicate a newly active television station and a newly active television program;
updating the second program listing for the newly active television station.

16. The method of claim 15, further comprising:
in response to the first cursor input:
updating a program note for the newly active television program, the program note comprising at least one of (1) a description, (2) a long title, (3) a duration, (4) a category, (5) a release year, and (5) a rating.

17. The method of claim 15, further comprising:
receiving a second cursor input from the user to scroll in a second direction through the first list;
in response to the second cursor input:
updating the first program listing for a newly active TV program, the first program listing now comprising:
a time of a newly active start time of the newly active TV program;
a third list of television stations and titles of television programs corresponding to the television stations, wherein the television programs in the third list are scheduled to be broadcasted by the corresponding television stations at the newly active start time;
updating the second program listing for the newly active time slot, the second program listing now comprising:
a fourth list of start times and titles of television programs corresponding to the start times, wherein the television programs in the fourth list are scheduled to be broadcasted by the active television station at the corresponding start times.

18. The method of claim 17, further comprising:
in response to the second cursor input:
updating a program note for the newly active television program, the program note comprising at least one of (1) a description, (2) a long title, (3) a duration, (4) a category, (5) a release year, and (5) a rating.

19. The method of claim 9, wherein the first program listing further includes additional information for at least one of the television programs adjacent to its title.

20. The method of claim 9, wherein the first program listing further includes a visual indicator that identifies a television program that is scheduled to start prior to the active start time.
